(19) United States
(12) Patent Application Publication
(10) Pub. No.: US 2016/0373230 A1
(43) Pub. Date: Dec. 22, 2016

(54) MOBILE COMMUNICATION SYSTEM, USER TERMINAL, AND COMMUNICATION CONTROL METHOD

(71) Applicant: KYOCERA CORPORATION, Kyoto-shi (JP)

(72) Inventors: Kugo MORITA, Yokohama-shi (JP); Chiharu YAMAZAKI, Ota-ku (JP)

(73) Assignee: KYOCERA CORPORATION, Kyoto (JP)

(21) Appl. No.: 14/901,410

(22) PCT Filed: Jun. 24, 2014
(86) PCT No.: PCT/JP2014/066706

§ 371 Date: Dec. 28, 2015

(30) Foreign Application Priority Data
Jun. 26, 2013 (JP) 2013-133653

(51) Int. Cl. H04L 5/00; H04W 72/04; H04B 7/06; H04L 1/00

(52) U.S. Cl. CPC H04L 5/0057; H04L 1/0026; H04W 72/042; H04B 7/0617; H04B 7/024

(57) ABSTRACT

UE 100-1 transmits null-steering control information for directing a null to the UE 100-1 in a transmission from eNB 200-2 to UE 100-2, and first channel quality information on a modulation and coding scheme recommended when the null-steering control information is adopted in the eNB 200-2, to eNB 200-1. The UE 100-1 controls to transmit, instead of transmitting the first channel quality information or in addition to transmitting the first channel quality information, second channel quality information on a modulation and coding scheme recommended when the null-steering control information is not adopted in the eNB 200-2, to the eNB 200-1.

### TECHNICAL FIELD

The present invention relates to a mobile communication system that supports downlink multi-antenna transmission, a user terminal thereof, and a communication control method thereof.

### BACKGROUND ART

An LTE system of which the specifications are formulated in 3GPP (3rd Generation Partnership Project), which is a project aiming to standardize a mobile communication system, supports downlink multi-antenna transmission (see Non Patent Literature 1). For example, a base station included in a radio access network performs beamforming that directs a beam to one user terminal and performs null steering that directs a null to another user terminal. In this way, it is possible to improve usage efficiency of radio resources while suppressing interference.

As an example of the downlink multi-antenna transmission, there is CB (Coordinated Beamforming)-CoMP (Coordinated Multi Point). In the CB-CoMP, a base station that manages a cell receives beamforming control information transmitted from each of a plurality of terminals subject to beamforming connected with the cell of the base station, and null-steering control information transmitted from a terminal subject to null steering connected with a neighboring cell. Then, the base station selects, as a pair terminal that forms a pair with the terminal subject to null steering, a terminal subject to beamforming that transmits the beamforming control information that matches the null-steering control information.

### CITATION LIST

### Non Patent Literature

[NPL 1] 3GPP Technical Report “TS 36.331 V11.3.0” Mar. 18, 2013

### SUMMARY OF INVENTION

The user terminal transmits to a serving cell channel quality information on a recommended modulation and coding scheme. The user terminal that transmits the null-steering control information (terminal subject to null steering) desirably transmits corrected channel quality information to the serving cell, hoping that the channel quality is improved by the null steering.

However, when there is no appropriate pair terminal, for example, it may be probable that the transmitted null-steering control information is not adopted. Therefore, there is a problem that the channel quality information corrected in accordance with the null-steering control information may be inappropriate, and thus, the modulation and coding scheme is not appropriately set in the serving cell.

Therefore, an object of the present invention is to provide a mobile communication system capable of appropriately setting a modulation and coding scheme when the downlink multi-antenna transmission is applied, a user terminal thereof, and a communication control method therefor.

A mobile communication system according to a first aspect transmits by downlink multi-antenna transmission from a radio access network to a user terminal. The user terminal comprises a transmitter configured to transmit null-steering control information for directing a null to the user terminal in a transmission from the radio access network to another user terminal, and first channel quality information on a modulation and coding scheme recommended when the null-steering control information is adopted in the radio access network, to the radio access network; and a controller configured to control to transmit, instead of transmitting the first channel quality information or in addition to transmitting the first channel quality information, second channel quality information on a modulation and coding scheme recommended when the null-steering control information is not adopted in the radio access network, to the radio access network.

A user terminal according to a second aspect is used in a mobile communication system transmitting by downlink multi-antenna transmission from a radio access network. The user terminal comprises a transmitter configured to transmit null-steering control information for directing a null to the user terminal in a transmission from the radio access network to another user terminal, and first channel quality information on a modulation and coding scheme recommended when the null-steering control information is adopted in the radio access network, to the radio access network; and a controller configured to control to transmit, instead of transmitting the first channel quality information or in addition to transmitting the first channel quality information, second channel quality information on a modulation and coding scheme recommended when the null-steering control information is not adopted in the radio access network, to the radio access network.

A communication control method according to a third aspect is used in a mobile communication system transmitting by downlink multi-antenna transmission from a radio access network to a user terminal. The communication control method comprises the steps of: transmitting, by the user terminal, null-steering control information for directing a null to the user terminal in a transmission from the radio access network to another user terminal, and first channel quality information on a modulation and coding scheme recommended when the null-steering control information is adopted in the radio access network, to the radio access network; and transmitting, by the user terminal, instead of transmitting the first channel quality information or in addition to transmitting the first channel quality information, second channel quality information on a modulation and coding scheme recommended when the null-steering control information is not adopted in the radio access network, to the radio access network.

### BRIEF DESCRIPTION OF DRAWINGS

FIG. 1 is a configuration diagram of an LTE system according to an embodiment.

FIG. 2 is a block diagram of UE according to the embodiment.

FIG. 3 is a block diagram of eNB according to the embodiment.

FIG. 4 is a protocol stack diagram of a radio interface according to the embodiment.

FIG. 5 is a configuration diagram of a radio frame according to the embodiment.

FIG. 6 is a diagram for describing CB-CoMP according to the embodiment.

FIG. 7 is a diagram for describing CB-CoMP according to the embodiment.

FIG. 8 is a diagram for describing a relationship between beamforming control information and an interference level according to the embodiment.

FIG. 9 is an operation flow diagram of the eNB according to the embodiment.

FIG. 10 is a diagram for describing an operation overview of the LTE system according to the embodiment.

FIG. 11 is a sequence diagram of an operation pattern 1 of the LTE system according to the embodiment.

FIG. 12 is a sequence diagram of an operation pattern 2 of the LTE system according to the embodiment.

FIG. 13 is a sequence diagram of an operation pattern 3 of the LTE system according to the embodiment.

FIG. 14 is a diagram for describing MU-MIMO according to a modification of the embodiment.

FIG. 15 is a diagram for describing MU-MIMO according to the modification of the embodiment.

### DESCRIPTION OF EMBODIMENTS

### Overview of Embodiments

A mobile communication system according to embodiments transmits by downlink multi-antenna transmission from a radio access network to a user terminal. The user terminal comprises a transmitter configured to transmit null-steering control information for directing a null to the user terminal in a transmission from the radio access network to another user terminal, and first channel quality information on a modulation and coding scheme recommended when the null-steering control information is adopted in the radio access network, to the radio access network; and a controller configured to control to transmit, instead of transmitting the first channel quality information or in addition to transmitting the first channel quality information, second channel quality information on a modulation and coding scheme recommended when the null-steering control information is not adopted in the radio access network, to the radio access network.

In the embodiments, when not adopting the null-steering control information from the user terminal, the radio access network adopts previously defined null-steering control information. The second channel quality information is information on a modulation and coding scheme recommended when the previously defined null-steering control information is adopted in the radio access network.

In the embodiments, the user terminal further comprises a receiver configured to receive, from the radio access network, setting information for switching to the second channel quality information when transmitting the first channel quality information. The controller controls, upon receiving the setting information in the receiver, to transmit to the radio access network the second channel quality information instead of transmitting the first channel quality information.

In the embodiments, the radio access network comprises a first base station configured to manage a serving cell of the user terminal; and a second base station configured to manage a serving cell of the other user terminal. The first base station receives the null-steering control information from the user terminal and transfers the null-steering control information to the second base station. The second base station transmits a notification regarding whether or not to adopt the null-steering control information, to the first base station.

In the embodiments, when a period during which the null-steering control information is not adopted exceeds a constant period, the first base station transmits to the user terminal setting information for switching to the second channel quality information.

A user terminal according to the embodiments is used in a mobile communication system transmitting by downlink multi-antenna transmission from a radio access network. The user terminal comprises a transmitter configured to transmit null-steering control information for directing a null to the user terminal in a transmission from the radio access network to another user terminal, and first channel quality information on a modulation and coding scheme recommended when the null-steering control information is adopted in the radio access network, to the radio access network; and a controller configured to control to transmit, instead of transmitting the first channel quality information or in addition to transmitting the first channel quality information, second channel quality information on a modulation and coding scheme recommended when the null-steering control information is not adopted in the radio access network, to the radio access network.

A communication control method according to the embodiments is used in a mobile communication system transmitting by downlink multi-antenna transmission from a radio access network to a user terminal. The communication control method comprises the steps of: transmitting, by the user terminal, null-steering control information for directing a null to the user terminal in a transmission from the radio access network to another user terminal, and first channel quality information on a modulation and coding scheme recommended when the null-steering control information is adopted in the radio access network, to the radio access network; and transmitting, by the user terminal, instead of transmitting the first channel quality information or in addition to transmitting the first channel quality information, second channel quality information on a modulation and coding scheme recommended when the null-steering control information is not adopted in the radio access network, to the radio access network.

### Embodiments

An embodiment in which the present invention is applied to an LTE system will be described, below.

(System Configuration)

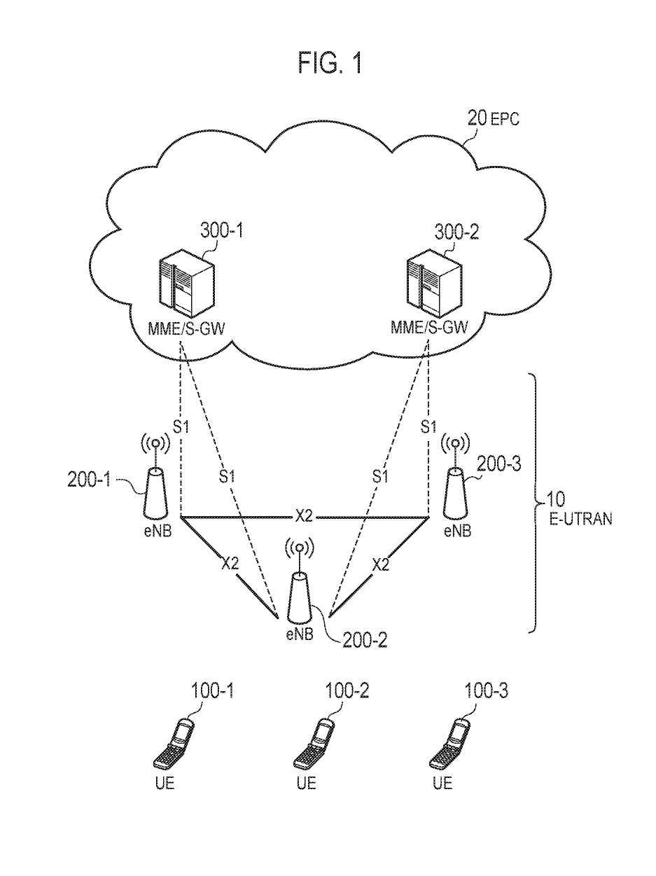

FIG. 1 is a configuration diagram of the LTE system according to the embodiment. As shown in FIG. 1, the LTE system according to the embodiment includes UE (User Equipment) 100, E-UTRAN (Evolved-UMTS Terrestrial Radio Access Network) 10, and EPC (Evolved Packet Core) 20.

The UE 100 corresponds to a user terminal. The UE 100 is a mobile communication device, which performs radio communication with a cell (serving cell) with which a connection is established. The configuration of the UE 100 will be described later.

The E-UTRAN 10 corresponds to a radio access network. The E-UTRAN 10 includes eNB 200 (evolved Node-B). The eNB 200 corresponds to a base station. The eNB 200 is connected mutually via an X2 interface. The configuration of the eNB 200 will be described later.

The eNB 200 manages one or a plurality of cells, and performs radio communication with the UE 100 which establish a connection with a cell of the eNB 200. The eNB 200 has a radio resource management (RRM) function, a routing function of user data, a measurement control function for mobility control and scheduling, and the like. The “cell” is used as a term indicating a smallest unit of a radio communication area, and is also used as a term indicating a function of performing radio communication with the UE 100.

The EPC 20 corresponds to a core network. The EPC 20 includes MME (Mobility Management Entity)/S-GW (Serving-Gateway) 300. The MME performs various types of mobility control and the like for the UE 100. The SGW performs transfer control of the user data. The MME/S-GW 300 is connected to the eNB 200 via an S1 interface.

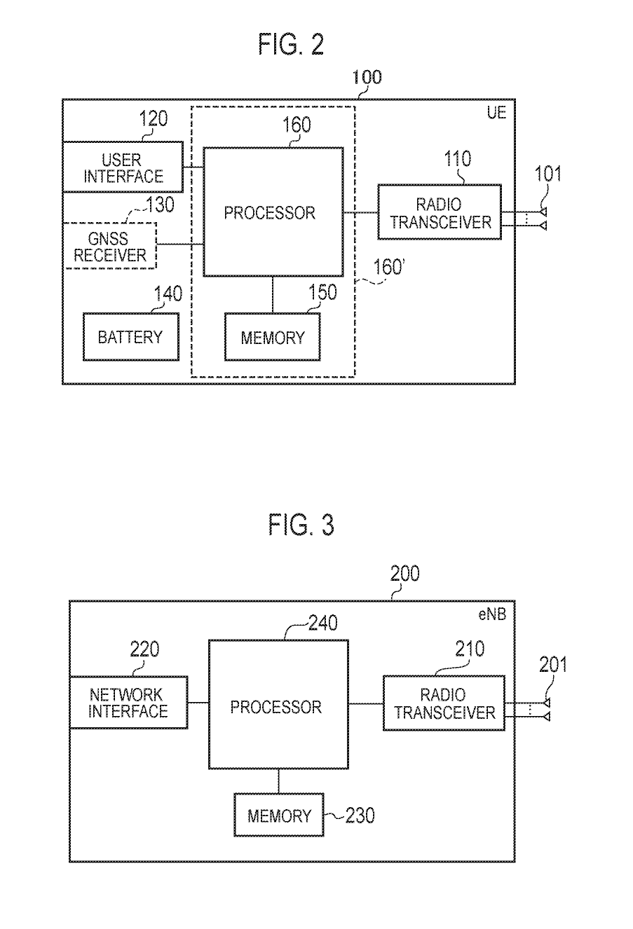

FIG. 2 is a block diagram of the UE 100. As shown in FIG. 2, the UE 100 includes a plurality of antennas 101, a radio transceiver 110, a user interface 120, a GNSS (Global Navigation Satellite System) receiver 130, a battery 140, a memory 150, and a processor 160. The memory 150 and the processor 160 configure a controller. The UE 100 may not necessarily have the GNSS receiver 130. Furthermore, the memory 150 may be integrally formed with the processor 160, and this set (that is, a chip set) may be called a processor 160′.

The plurality of antennas 101 and the radio transceiver 110 are used to transmit and receive a radio signal. The radio transceiver 110 converts a baseband signal (transmission signal) output from the processor 160 into a radio signal, and transmits the radio signal from the plurality of antennas 101. Furthermore, the radio transceiver 110 converts a radio signal received by the plurality of antennas 101 into a baseband signal (reception signal), and outputs the baseband signal to the processor 160.

The user interface 120 is an interface with a user carrying the UE 100, and includes, for example, a display, a microphone, a speaker, various buttons, and the like. The user interface 120 receives an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for processing by the processor 160. The processor 160 includes a baseband processor that performs modulation and demodulation, coding and decoding, and the like on the baseband signal, and a CPU (Central Processing Unit) that performs various types of processes by executing the program stored in the memory 150. The processor 160 may further include a codec that performs encoding and decoding on sound and video signals. The processor 160 executes various types of processes and various communication protocols described later.

FIG. 3 is a block diagram of the eNB 200. As shown in FIG. 3, the eNB 200 includes a plurality of antennas 201, a radio transceiver 210, a network interface 220, a memory 230, and a processor 240. The memory 230 and the processor 240 configure a controller.

The plurality of antennas 201 and the radio transceiver 210 are used to transmit and receive a radio signal. The radio transceiver 210 converts a baseband signal (transmission signal) output from the processor 240 into a radio signal, and transmits the radio signal from the plurality of antennas 201. Furthermore, the radio transceiver 210 converts a radio signal received by the plurality of antennas 201 into a baseband signal (reception signal), and outputs the baseband signal to the processor 240.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for processing by the processor 240. The processor 240 includes a baseband processor that performs modulation and demodulation, coding and decoding, and the like on the baseband signal, and a CPU that performs various types of processes by executing the program stored in the memory 230. The processor 240 executes various types of processes and various communication protocols described later.

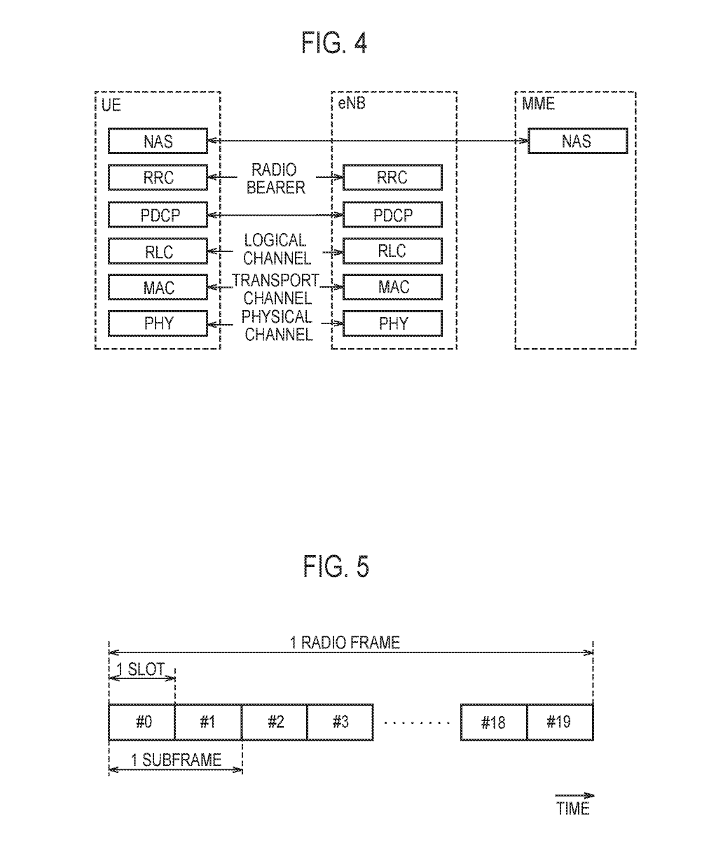

FIG. 4 is a protocol stack diagram of a radio interface in the LTE system. As shown in FIG. 4, the radio interface protocol is classified into a first layer to a third layer of an OSI reference model, such that the first layer is a physical (PHY) layer. The second layer includes a MAC (Media Access Control) layer, an RLC (Radio Link Control) layer, and a PDCP (Packet Data Convergence Protocol) layer. The third layer includes an RRC (Radio Resource Control) layer.

The physical layer performs coding and decoding, modulation and demodulation, antenna mapping and demapping, and resource mapping and demapping. The physical layer of the eNB 200 performs the downlink multi-antenna transmission by applying a precoder matrix (transmission antenna weight) and a rank (signal sequence number). The downlink multi-antenna transmission according to the embodiment will be described in detail, later. Between the physical layer of the UE 100 and the physical layer of the eNB 200, user data and control signals are transmitted via a physical channel.

The MAC layer performs priority control of data, and a retransmission process and the like by a hybrid ARQ (HARQ). Between the MAC layer of the UE 100 and the MAC layer of the eNB 200, user data and control signals are transmitted via a transport channel. The MAC layer of the eNB 200 includes a scheduler for determining a transport format (a transport block size and a modulation and coding scheme) of an uplink and a downlink, and a resource block to be assigned to the UE 100.

The RLC layer transmits data to an RLC layer of a reception side by using the functions of the MAC layer and the physical layer. Between the RLC layer of the UE 100 and the RLC layer of the eNB 200, user data and control signals are transmitted via a logical channel.

The PDCP layer performs header compression and decompression, and encryption and decryption.

The RRC layer is defined only in a control plane that handles control signals. Between the RRC layer of the UE 100 and the RRC layer of the eNB 200, a control signal (RRC message) for various types of settings is transmitted. The RRC layer controls the logical channel, the transport channel, and the physical channel according to the establishment, re-establishment, and release of a radio bearer. When a connection (RRC connection) is established between the RRC of the UE 100 and the RRC of the eNB 200, the UE 100 is in a connected state (RRC connected state), and when the connection is not established, the UE 100 is in an idle state (RRC idle state).

An NAS (Non-Access Stratum) layer positioned above the RRC layer performs session management, mobility management, and the like.

FIG. 5 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As shown in FIG. 5, a radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each of the resource blocks includes a plurality of subcarriers in the frequency direction. Among radio resources assigned to the UE 100, a frequency resource can be specified by a resource block and a time resource can be specified by a subframe (or a slot).

In the downlink, an interval of several symbols at the head of each subframe is a region used as a physical downlink control channel (PDCCH) for mainly transmitting a control signal. Furthermore, the remaining portion of each subframe is a region available as a physical downlink shared channel (PDSCH) for mainly transmitting user data.

In the uplink, both ends in the frequency direction of each subframe are regions used as a physical uplink control channel (PUCCH) for mainly transmitting a control signal. The remaining portion in each subframe is a region available as a physical uplink shared channel (PUSCH) for mainly transmitting user data.

(CB-CoMP)

The LTE system according to the present embodiment supports CB-CoMP which is a mode of the downlink multi-antenna transmission. In the CB-CoMP, a plurality of eNBs 200 work together to perform the beamforming and the null steering.

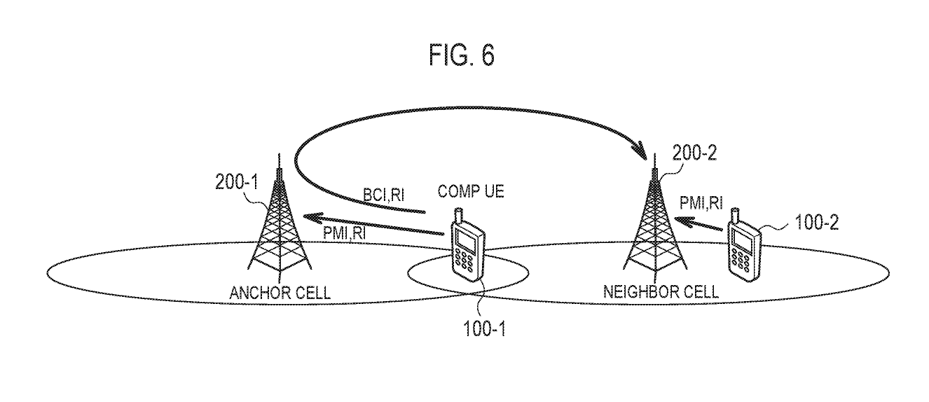

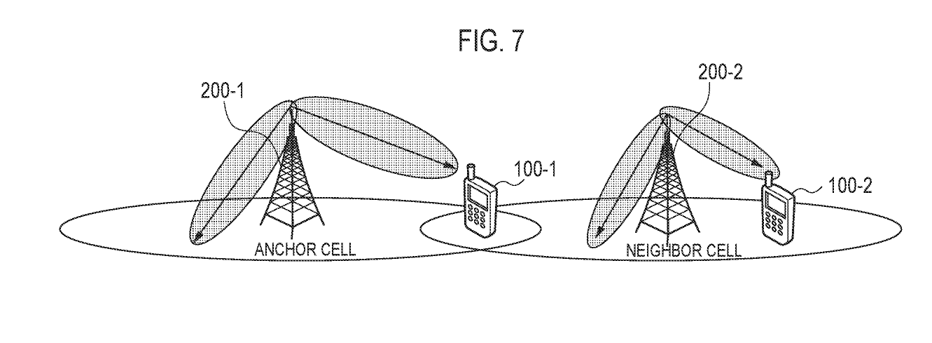

FIG. 6 and FIG. 7 are diagrams for describing the CB-CoMP. As shown in FIG. 6, eNB 200-1 and eNB 200-2 manage cells adjacent to each other. Further, the cell of the eNB 200-1 and the cell of the eNB 200-2 belong to the same frequency.

The UE 100-1 is in a state of establishing connection with a cell of the eNB 200-1 (connected state). That is, the UE 100-1 uses, as the serving cell, the cell of the eNB 200-1 to perform communication.

On the other hand, the UE 100-2 is in a state of establishing connection with a cell of the eNB 200-2 (connected state). That is, the UE 100-2 uses, as the serving cell, the cell of the eNB 200-2 to perform communication. In FIG. 6, only one UE 100-2 is shown which establishes the connection with the cell of the eNB 200-2; however, in a real environment, a plurality of UEs 100-2 establish the connection with the cell of the eNB 200-2.

The UE 100-1 is located at a boundary area of the cell of the eNB 200-1 and the cell of the eNB 200-2. In this case, the UE 100-1 is influenced by interference from the cell of the eNB 200-2. When the CB-CoMP is applied to the UE 100-1, it is possible to suppress the interference received in the UE 100-1.

A communication procedure of the CB-CoMP when the CB-CoMP is applied to the UE 100-1 will be described, below. It is noted that the UE 100-1 to which the CB-CoMP is applied may be called a “CoMP UE”. That is, the UE 100-1 corresponds to a terminal subject to null steering. The serving cell of the UE 100-1 (CoMP UE) may be called an “anchor cell”.

Each of the UE 100-1 and the UE 100-2 feeds beamforming control information for directing a beam to the UEs 100-1 and 100-2, back to the serving cell, on the basis of a reference signal received from the serving cell, for example. In the embodiment, the beamforming control information includes a precoder matrix indicator (PMI) and a rank indicator (RI). The PMI is an indicator indicating a precoder matrix (transmission antenna weight) recommended to the serving cell. The RI is an indicator indicating a rank (signal sequence number) recommended to the serving cell. Each of the UE 100-1 and the UE 100-2, which holds a table (code book) in which the precoder matrix and the indicator are associated, selects the precoder matrix that improves communication quality of a desired wave, and feeds back, as the PMI, the indicator corresponding to the selected precoder matrix.

The UE 100-1 further feeds null-steering control information for directing a null to the UE 100-1, back to the serving cell, on the basis of a reference signal received from a neighboring cell, for example. In the embodiment, the null-steering control information includes BCI (Best Companion PMI) and the RI. The BCI is an indicator indicating a precoder matrix (transmission antenna weight) recommended to the neighboring cell. The UE 100-1, which holds a table (code book) in which the precoder matrix and the indicator are associated, selects the precoder matrix that reduces a reception level of an interference wave or reduces influence to a desired wave, and feeds back, as the BCI, the indicator corresponding to the selected precoder matrix.

The eNB 200-1 transfers the null-steering control information (BCI, RI) fed back from the UE 100-1, to the eNB 200-2.

The eNB 200-2 receives the beamforming control information (PMI, RI) fed back from each of the plurality of UEs 100-2 connected with a cell of the eNB 200-2 and the null-steering control information (BCI, RI) fed back from the UE 100-1 connected with the neighboring cell. Then, the eNB 200-2 selects the UE 100-2 that feeds back the beamforming control information that matches the null-steering control information, as a pair UE (pair terminal) that forms a pair with the UE 100-1. In the embodiment, the “beamforming control information that matches the null-steering control information” is beamforming control information that includes a combination of the PMI and the RI that matches a combination of the BCI and the RI included in the null-steering control information.

When selecting the pair UE (UE 100-2), the eNB 200-2 assigns the same radio resource as the radio resource assigned to the UE 100-1, to the pair UE. Then, the eNB 200-2 applies the beamforming control information (PMI, RI) fed back from the pair UE, and performs a transmission to the pair UE. As a result, as shown in FIG. 7, the eNB 200-2 is capable of performing a transmission to the pair UE by directing a beam to the pair UE while directing a null to the UE 100-1.

(Operation According to Embodiment)

(1) Operation of eNB 200-2

As described above, the eNB 200-2 selects, as the pair UE that forms a pair with the UE 100-1, the UE 100-2 that feeds back the beamforming control information (PMI, RI) that matches the null-steering control information (BCI, RI) fed back from the UE 100-1. Here, the UE 100-1 corresponds to the terminal subject to null steering and the UE 100-2 corresponds to the terminal subject to beamforming.

However, when there is no UE 100-2 that feeds back the beamforming control information that matches the null-steering control information, the eNB 200-2 is not capable of selecting the pair UE that forms a pair with the UE 100-1, and is not capable of applying the CB-CoMP.

Therefore, when there is no UE 100-2 that feeds back the beamforming control information that matches the null-steering control information, the eNB 200-2 selects, as the pair UE, the UE 100-2 that feeds back the beamforming control information including a previously defined RI.

In the embodiment, the previously defined RI is an RI having the largest number of ranks (signal sequence numbers) out of a plurality of RIs available in the LTE system. In the LTE system, the ranks are defined from 1 to 4. That is, it is defined so that signal sequences from a 1-signal sequence (RI=1) to a 4-signal sequence (RI=4) are multiplexed.

Here, the greater the number of signal sequences to be multiplexed, the lower the power density per one signal sequence. Thus, when the transmission is performed by applying the PMI that does not match the BCI, even when the beam is directed to the UE 100-1, it is possible to decrease the interference level in the UE 100-1.

In other words, the previously defined RI is an RI having the smallest variation in interfering level when combined with each of a plurality of PMIs available in the LTE system, out of a plurality of RIs available in the LTE system.

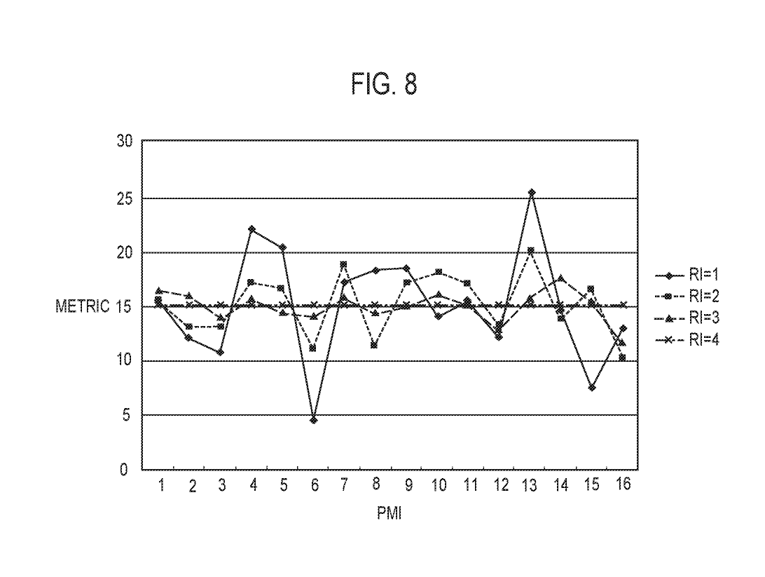

FIG. 8 is a diagram for describing a relationship between the beamforming control information applied by the eNB 200-2 and the interference level in the UE 100-1. FIG. 8 shows a simulation result when the beamforming control information which does not match the null-steering control information fed back from the UE 100-1 is applied.

As shown in FIG. 8, when the 1-signal sequence (RI=1) is concerned, the power density per one signal sequence is high, and thus, the interference level in the UE 100-1 greatly varies depending on each PMI applied by the eNB 200-2. That is, when RI=1, the variation in interfering level when combined with each of a plurality of PMIs (PMI=1 to 16) available in the LTE system is the largest.

On the other hand, when the 4-signal sequence (RI=4) is concerned, the power density per one signal sequence is low, and thus, the interference level in the UE 100-1 only slightly varies irrespective of each PMI applied by the eNB 200-2. That is, when RI=4, the variation in interfering level when combined with each of a plurality of PMIs (PMI=1 to 16) available in the LTE system is the smallest.

Thus, when the beamforming control information which does not match the null-steering control information fed back from the UE 100-1 is applied, if the beamforming control information including RI=4 is applied, then it is possible to decrease the interference level in the UE 100-1.

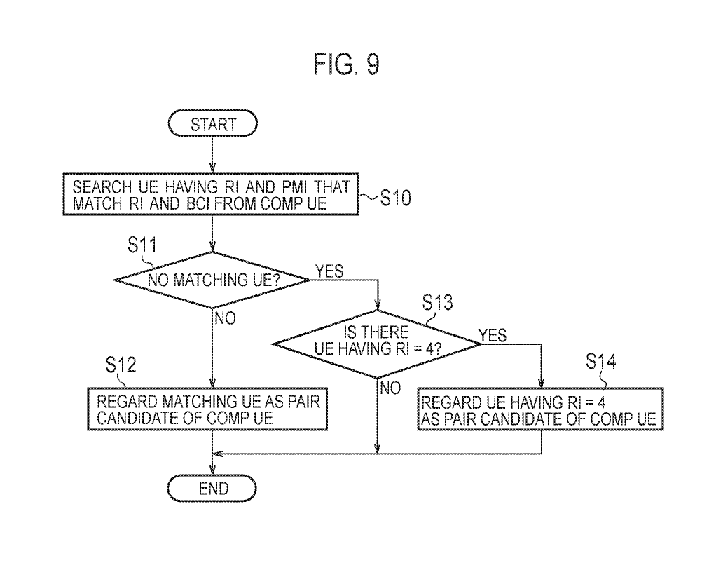

FIG. 9 is an operation flow diagram of the eNB 200-2 according to the embodiment. Prior to the present flow, the radio transceiver 210 of the eNB 200-2 receives the beamforming control information (PMI, RI) fed back from each of the plurality of UEs 100-2 connected with a cell of the eNB 200-2. Further, the network interface 220 of the eNB 200-2 receives, by way of the eNB 200-1, the null-steering control information (BCI, RI) fed back from the UE 100-1 (CoMP UE) connected with the neighboring cell.

As shown in FIG. 9, in step S10, the processor 240 of the eNB 200-2 searches the UE 100-2 that feeds back the beamforming control information that matches the null-steering control information.

In step S11, the processor 240 of the eNB 200-2 confirms whether or not there is the UE 100-2 that feeds back the beamforming control information that matches the null-steering control information.

When there is the UE 100-2 that feeds back the beamforming control information that matches the null-steering control information (step S11: NO), in step S12, the processor 240 of the eNB 200-2 selects the UE 100-2 that feeds back the beamforming control information that matches the null-steering control information, as the pair UE of the UE 100-1 (CoMP UE).

On the other hand, when there is no UE 100-2 that feeds back the beamforming control information that matches the null-steering control information (step S11: YES), in step S13, the processor 240 of the eNB 200-2 confirms whether or not there is the UE 100-2 that feeds back the beamforming control information including RI=4.

When there is no UE 100-2 that feeds back the beamforming control information including RI=4 (step S13: NO), it is not possible to select an appropriate pair UE, and thus, the application of the CB-CoMP is stopped. For example, the eNB 200-2 does not assign, in its own cell, the same radio resource as the radio resource assigned to the UE 100-1 (CoMP UE).

On the other hand, when there is the UE 100-2 that feeds back the beamforming control information including RI=4 (step S13: YES), in step S14, the processor 240 of the eNB 200-2 selects, as the pair UE of the UE 100-1 (CoMP UE), the UE 100-2 that feeds back the beamforming control information including RI=4.

When selecting the pair UE (UE 100-2), the eNB 200-2 assigns the same radio resource as the radio resource assigned to the UE 100-1, to the pair UE. Then, the eNB 200-2 applies the beamforming control information (PMI, RI) fed back from the pair UE, and performs a transmission to the pair UE. As a result, as shown in FIG. 7, the eNB 200-2 is capable of performing a transmission to the pair UE by directing a beam to the pair UE while directing a null to the UE 100-1.

(2) Entire Operation

Next, an entire operation of the LTE system according to the embodiment will be described.

(2.1) Operation Overview

The UE 100-1 (CoMP UE) transmits channel quality information (CQI: Channel Quality Indicator) on a recommended modulation and coding scheme (MCS), to the eNB 200-1. The UE 100-1 that transmits the null-steering control information desirably transmits corrected CQI to the eNB 200-1, hoping that the channel quality is improved by the null steering.

However, when there is no UE 100-2 that feeds back the beamforming control information that matches the null-steering control information, the eNB 200-2 selects, as the pair UE, the UE 100-2 that feeds back the beamforming control information including RI=4. In this case, the null-steering control information fed back from the UE 100-1 is not adopted in the eNB 200-2.

Thus, when the UE 100-1 corrects the CQI to match the null-steering control information, the CQI may be inappropriate, and thus, the MCS for the UE 100-1 may not be set appropriately in the eNB 200-1.

For example, a case is assumed where the UE 100-1 transmits the CQI corresponding to the MCS having a high transmission rate and a low error resistance to the eNB 200-1, hoping that the channel quality is greatly improved by the null-steering control information to be fed back.

In such a case, when the eNB 200-2 does not adopt the null-steering control information and adopts the previously defined RI=4, the UE 100-1 may not expect an anticipated improvement. However, the eNB 200-1 applies the MCS having a high transmission rate and a low error resistance in accordance with the CQI from the UE 100-1 and performs a transmission to the UE 100-1, and thus, a transmission error occurs.

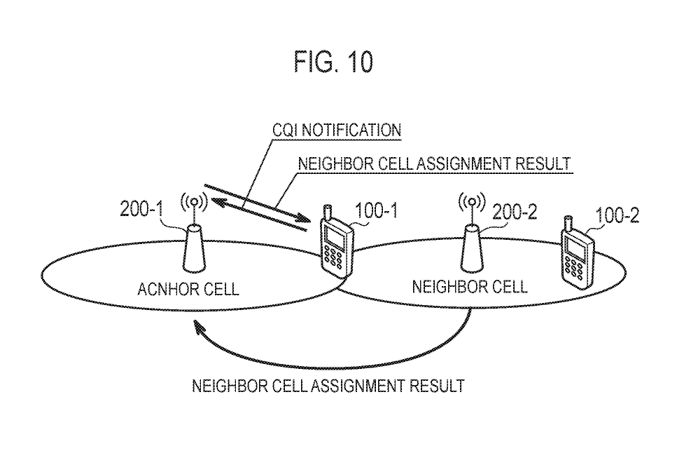

Thus, in the embodiment, the eNB 200-1 is configured to be capable of appropriately setting the MCS in accordance with a method described below. FIG. 10 is a diagram for describing an operation overview of the LTE system according to the embodiment.

As shown in FIG. 10, the UE 100-1 transmits the null-steering control information for directing a null to the UE 100-1 in a transmission from the eNB 200-2 to the UE 100-2, and first CQI regarding the MCS recommended when the null-steering control information is adopted in the eNB 200-2, to the eNB 200-1. Further, the UE 100-1 transmits, instead of transmitting the first CQI or in addition to transmitting the first CQI, second CQI regarding the MCS recommended when the null-steering control information is not adopted in the eNB 200-2, to the eNB 200-1.

Thus, when the two types of CQI are defined, it is possible to deal with both cases where the null-steering control information is adopted in the eNB 200-2 and where the null-steering control information is not adopted in the eNB 200-2. Therefore, it is possible to appropriately set the MCS for the UE 100-1 in the eNB 200-1.

In the embodiment, the second CQI is information on the MCS recommended when the previously defined null-steering control information (that is, RI=4) is adopted in the eNB 200-2. Thus, when the second CQI optimized at RI=4 is transmitted from the UE 100-1 to the eNB 200-1, even if the eNB 200-2 adopts RI=4, it is possible to appropriately set the MCS for the UE 100-1 in the eNB 200-1.

In the embodiment, the eNB 200-1 receives the null-steering control information from the UE 100-1 and transfers the null-steering control information to the eNB 200-2. The eNB 200-2 transmits a notification (Neighbor Cell assignment result) regarding whether or not the null-steering control information is adopted, to the eNB 200-1. This allows the eNB 200-1 to grasp whether or not the null-steering control information is adopted in the eNB 200-2, and thus, it is possible to appropriately determine which of the two types of CQI should be selected.

In the embodiment, when a period during which the null-steering control information is not adopted exceeds a constant period, the eNB 200-1 transmits setting information (Neighbor Cell assignment result) for switching to the second CQI, to the UE 100-1. As a result, when the null-steering control information is not adopted in the eNB 200-2 over a long period of time, it is possible to switch from the first CQI to the second CQI.

In the embodiment, when transmitting the first CQI, the UE 100-1 receives the setting information (Neighbor Cell assignment result) for switching to the second CQI, from the eNB 200-1. Upon receiving the setting information, the UE 100-1 transmits, instead of transmitting the first CQI, the second CQI to the eNB 200-1. As a result, it is possible to appropriately use the two different types of CQI.

An overall operation of the LTE system according to the embodiment will be described in order of operation patterns 1 to 3, below.

(2.2) Operation Pattern 1

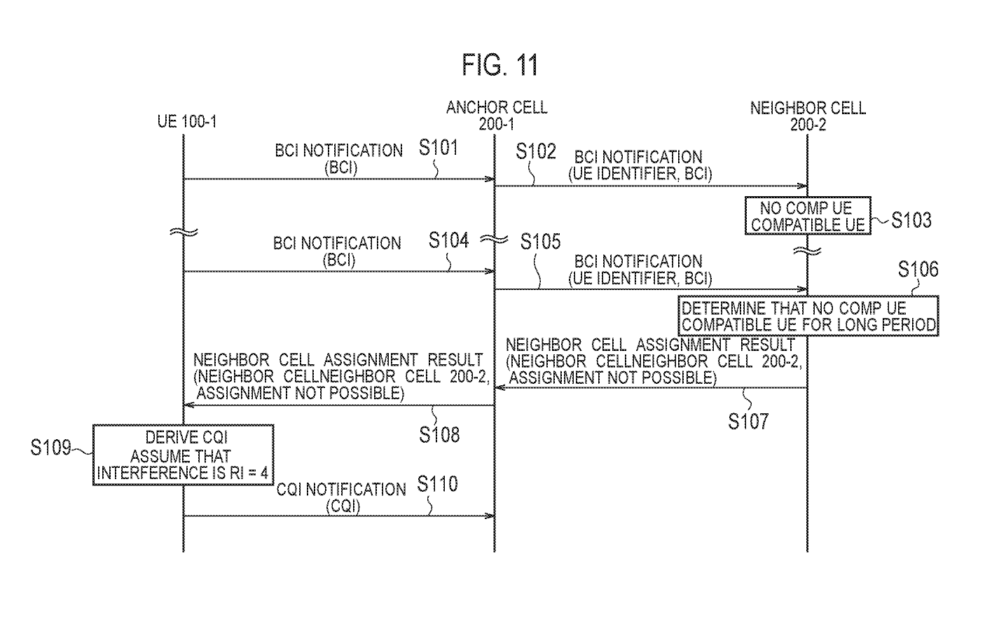

FIG. 11 is a sequence diagram of an operation pattern 1 of the LTE system according to the embodiment. In an initial state of the present sequence, the UE 100-1 transmits the first CQI to the eNB 200-1, and in accordance with the first CQI, the eNB 200-1 sets the MCS for the UE 100-1.

As shown in FIG. 11, in step S101, the UE 100-1 transmits the null-steering control information to the eNB 200-1. In step S102, the eNB 200-1 that receives the null-steering control information transfers, together with an identifier of the UE 100-1 (UE identifier), the null-steering control information to the eNB 200-2.

In step S103, the eNB 200-2 that receives the UE identifier and the null-steering control information confirms whether or not there is the UE 100-2 that feeds back the beamforming control information that matches the null-steering control information. Here, there is no UE 100-2 that feeds back the beamforming control information that matches the null-steering control information, and the eNB 200-2 selects, as the pair UE, the UE 100-2 that feeds back the beamforming control information including RI=4, for example. In response to the null-steering control information not being adopted, the eNB 200-2 activates a timer for timing a period during which the null-steering control information is not adopted.

Thereafter, in step S104, the UE 100-1 transmits the null-steering control information to the eNB 200-1. In step S105, the eNB 200-1 that receives the null-steering control information transfers, together with an identifier of the UE 100-1 (UE identifier), the null-steering control information to the eNB 200-2.

In step S106, the eNB 200-2 that receives the UE identifier and the null-steering control information confirms whether or not there is the UE 100-2 that feeds back the beamforming control information that matches the null-steering control information. Here, there is no UE 100-2 that feeds back the beamforming control information that matches the null-steering control information, and the eNB 200-2 selects, as the pair UE, the UE 100-2 that feeds back the beamforming control information including RI=4, for example. Further, the eNB 200-2 determines that the period during which the null-steering control information is not adopted exceeds a previously defined period.

In step S107, the eNB 200-2 transmits a notification (Neighbor Cell assignment not possible) indicating that the null-steering control information is not adopted over a long period of time, to the eNB 200-1.

In step S108, the eNB 200-1 that receives the notification (Neighbor Cell assignment not possible) transmits setting information (Neighbor Cell assignment not possible) for switching to the second CQI, to the UE 100-1.

In step S109, the UE 100-1 that receives the setting information (Neighbor Cell assignment not possible) switches to the second CQI to derive the second CQI assuming that RI=4.

In step S110, the UE 100-1 transmits, instead of the first CQI, the second CQI to the eNB 200-1. The eNB 200-1 that receives the second CQI applies the MCS corresponding to the second CQI to perform a transmission to the UE 100-1.

It is noted that after switching to the second CQI, when the UE 100-2 is discovered which feeds back the beamforming control information that matches the null-steering control information in the eNB 200-1, a notification indicating the discovery (Neighbor Cell assignment possible) may be transmitted from the eNB 200-2 to the eNB 200-1. The eNB 200-1 that receives the notification (Neighbor Cell assignment possible) may transmit setting information (Neighbor Cell assignment possible) for switching to the first CQI, to the UE 100-1.

(2.3) Operation Pattern 2

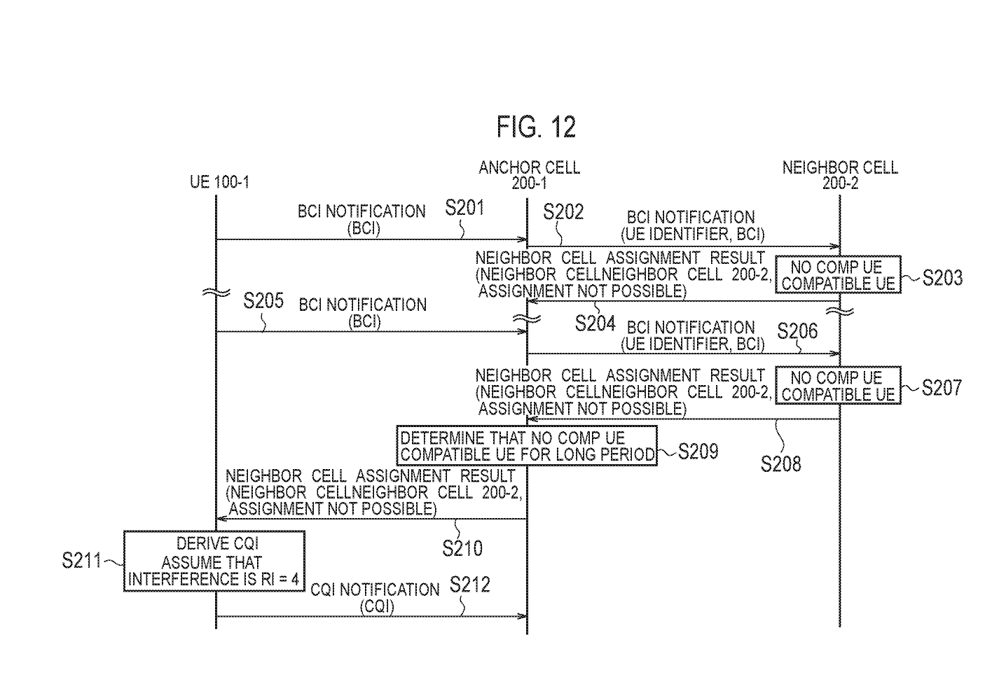

FIG. 12 is a sequence diagram of an operation pattern 2 of the LTE system according to the embodiment. In an initial state of the present sequence, the UE 100-1 transmits the first CQI to the eNB 200-1, and in accordance with the first CQI, the eNB 200-1 sets the MCS for the UE 100-1.

As shown in FIG. 12, in step S201, the UE 100-1 transmits the null-steering control information to the eNB 200-1. In step S202, the eNB 200-1 that receives the null-steering control information transfers, together with an identifier of the UE 100-1 (UE identifier), the null-steering control information to the eNB 200-2.

In step S203, the eNB 200-2 that receives the UE identifier and the null-steering control information confirms whether or not there is the UE 100-2 that feeds back the beamforming control information that matches the null-steering control information. Here, there is no UE 100-2 that feeds back the beamforming control information that matches the null-steering control information, and the eNB 200-2 selects, as the pair UE, the UE 100-2 that feeds back the beamforming control information including RI=4, for example.

In step S204, the eNB 200-2 transmits a notification (Neighbor Cell assignment not possible) indicating that the null-steering control information is not adopted, to the eNB 200-1. The eNB 200-1 that receives the notification (Neighbor Cell assignment not possible) activates a timer for timing a period during which the null-steering control information is not adopted.

Thereafter, in step S205, the UE 100-1 transmits the null-steering control information to the eNB 200-1. In step S206, the eNB 200-1 that receives the null-steering control information transfers, together with an identifier of the UE 100-1 (UE identifier), the null-steering control information to the eNB 200-2.

In step S207, the eNB 200-2 that receives the UE identifier and the null-steering control information confirms whether or not there is the UE 100-2 that feeds back the beamforming control information that matches the null-steering control information. Here, there is no UE 100-2 that feeds back the beamforming control information that matches the null-steering control information, and the eNB 200-2 selects, as the pair UE, the UE 100-2 that feeds back the beamforming control information including RI=4, for example.

In step S208, the eNB 200-2 transmits a notification (Neighbor Cell assignment not possible) indicating that the null-steering control information is not adopted, to the eNB 200-1.

In step S209, the eNB 200-1 that receives the notification (Neighbor Cell assignment not possible) determines that the period during which the null-steering control information is not adopted exceeds a previously defined period.

In step S210, the eNB 200-1 transmits setting information (Neighbor Cell assignment not possible) for switching to the second CQI, to the UE 100-1.

In step S211, the UE 100-1 that receives the setting information (Neighbor Cell assignment not possible) switches to the second CQI to derive the second CQI assuming that RI=4.

In step S212, the UE 100-1 transmits, instead of the first CQI, the second CQI to the eNB 200-1. The eNB 200-1 that receives the second CQI applies the MCS corresponding to the second CQI to perform a transmission to the UE 100-1.

It is noted that after switching to the second CQI, when the UE 100-2 is discovered which feeds back the beamforming control information that matches the null-steering control information in the eNB 200-1, a notification indicating the discovery (Neighbor Cell assignment possible) may be transmitted from the eNB 200-2 to the eNB 200-1. The eNB 200-1 that receives the notification (Neighbor Cell assignment possible) may transmit setting information (Neighbor Cell assignment possible) for switching to the first CQI, to the UE 100-1.

(2.4) Operation Pattern 3

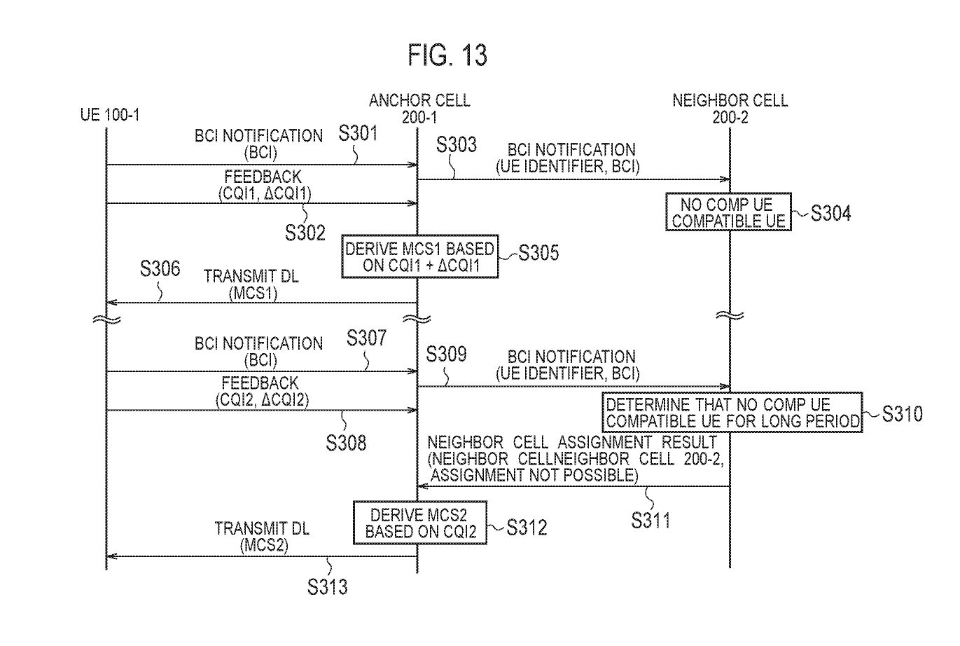

FIG. 13 is a sequence diagram of an operation pattern 3 of the LTE system according to the embodiment.

As shown in FIG. 13, in step S301, the UE 100-1 transmits the null-steering control information to the eNB 200-1. Further, in step S302, the UE 100-1 transmits a difference (ΔCQI1) between the first CQI and the second CQI, and the second CQI (CQI1), to the eNB 200-1.

In step S303, the eNB 200-1 that receives the null-steering control information transfers, together with an identifier of the UE 100-1 (UE identifier), the null-steering control information to the eNB 200-2.

In step S304, the eNB 200-2 that receives the UE identifier and the null-steering control information confirms whether or not there is the UE 100-2 that feeds back the beamforming control information that matches the null-steering control information. Here, there is no UE 100-2 that feeds back the beamforming control information that matches the null-steering control information, and the eNB 200-2 selects, as the pair UE, the UE 100-2 that feeds back the beamforming control information including RI=4, for example. In response to the null-steering control information not being adopted, the eNB 200-2 activates a timer for timing a period during which the null-steering control information is not adopted.

On the other hand, in step S305, the eNB 200-1 derives the MCS (MCS1) corresponding to the first CQI, on the basis of the difference (ΔCQI1) between the first CQI and the second CQI, and the second CQI (CQI1).

In step S306, the eNB 200-1 applies the MCS (MCS1) corresponding to the first CQI to perform a transmission to the UE 100-1.

Thereafter, in step S307, the UE 100-1 transmits the null-steering control information to the eNB 200-1. Further, in step S308, the UE 100-1 transmits a difference (ΔCQI2) between the first CQI and the second CQI, and the second CQI (CQI2), to the eNB 200-1.

In step S309, the eNB 200-1 that receives the null-steering control information transfers, together with an identifier of the UE 100-1 (UE identifier), the null-steering control information to the eNB 200-2.

In step S310, the eNB 200-2 that receives the UE identifier and the null-steering control information confirms whether or not there is the UE 100-2 that feeds back the beamforming control information that matches the null-steering control information. Here, there is no UE 100-2 that feeds back the beamforming control information that matches the null-steering control information, and the eNB 200-2 selects, as the pair UE, the UE 100-2 that feeds back the beamforming control information including RI=4, for example. Further, the eNB 200-2 determines that the period during which the null-steering control information is not adopted exceeds a previously defined period.

In step S311, the eNB 200-2 transmits a notification (Neighbor Cell assignment not possible) indicating that the null-steering control information is not adopted over a long period of time, to the eNB 200-1.

In step S312, the eNB 200-1 that receives the notification (Neighbor Cell assignment not possible) derives the MCS (MCS2) corresponding to the second CQI (CQI2).

In step S313, the eNB 200-1 applies the MCS (MCS2) corresponding to the second CQI (CQI2) to perform a transmission to the UE 100-1.

It is noted that after switching to the second CQI, when the UE 100-2 is discovered which feeds back the beamforming control information that matches the null-steering control information in the eNB 200-1, a notification indicating the discovery (Neighbor Cell assignment possible) may be transmitted from the eNB 200-2 to the eNB 200-1. The eNB 200-1 that receives the notification (Neighbor Cell assignment possible) may switch to the first CQI to perform a transmission to the UE 100-1.

[Modification of Embodiment]

In the above-described embodiment, an example is described where the present invention is applied to the CB-CoMP which is a mode of the downlink multi-antenna transmission; however, the present invention may be applied to MU (Multi-User)-MIMO (Multiple-Input and Multiple-Output) which is another mode of the downlink multi-antenna transmission. In a modification of the embodiment, a case will be described where the present invention is applied to the MU-MIMO.

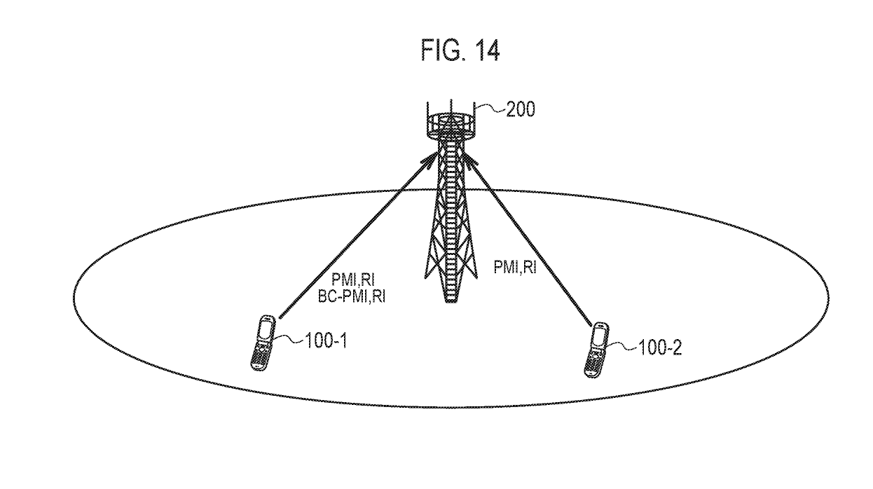

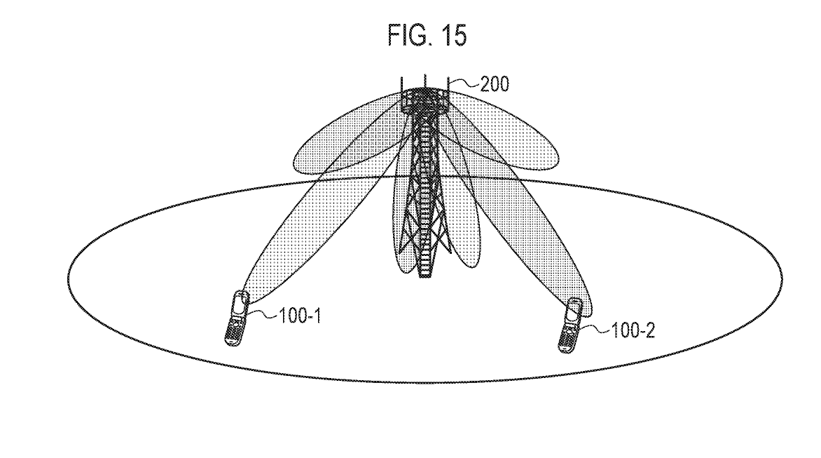

FIG. 14 and FIG. 15 are diagrams for describing the MU-MIMO. As shown in FIG. 14, each of the UE 100-1 and the UE 100-2 is in a state of establishing connection with a cell of the eNB 200 (connected state). That is, each of the UE 100-1 and the UE 100-2 uses, as a serving cell, the cell of the eNB 200 to perform communication. In FIG. 14, only two UEs 100 are shown which establish the connection with the cell of the eNB 200; however, in a real environment, three or more UEs 100 establish the connection with the cell of the eNB 200.

A communication procedure of the MU-MIMO when the MU-MIMO is applied to the UE 100-1 will be described, below. Here, the UE 100-1 corresponds to the terminal subject to null steering and the UE 100-2 corresponds to the terminal subject to beamforming. It is noted that a duplicated description with the above-described embodiment will be omitted.

Each of the UE 100-1 and the UE 100-2 feeds the beamforming control information for directing a beam to the UEs 100-1 and 100-2, back to the serving cell, on the basis of the reference signal received from the serving cell, for example. The beamforming control information includes the PMI and the RI.

The UE 100-1 further feeds the null-steering control information for directing a null to the UE 100-1, back to the serving cell, on the basis of the reference signal received from the serving cell, for example. The null-steering control information includes the BCI (Best Companion PMI) and the RI.

The eNB 200 receives the beamforming control information (PMI, RI) fed back from each of the plurality of UEs 100-2 connected with a cell of the eNB 200 and the null-steering control information (BCI, RI) fed back from the UE 100-1 connected with a cell of the eNB 200. Then, the eNB 200 selects the UE 100-2 that feeds back the beamforming control information that matches the null-steering control information, as a pair UE (pair UE) that forms a pair with the UE 100-1.

When selecting the pair UE (UE 100-2), the eNB 200 assigns the same radio resource as the radio resource assigned to the UE 100-1, to the pair UE. Then, the eNB 200 applies the beamforming control information (PMI, RI) fed back from the pair UE, and performs a transmission to the pair UE. As a result, as shown in FIG. 15, the eNB 200 is capable of performing a transmission to the pair UE by directing a beam to the pair UE while directing a null to the UE 100-1.

In the present modification, in the above-described operation patterns 1 to 3 (FIG. 11 to FIG. 13), when the eNB 200-1 and the eNB 200-2 are collectively regarded as one eNB 200, the eNB 200 is capable of appropriately setting the MCS for the UE 100-1, also in the MU-MIMO.

### OTHER EMBODIMENTS

In the above-described embodiment, the null-steering control information transmitted by the UE 100-1 is indirectly fed back to the eNB 200-2 via the eNB 200-1; however, the null-steering control information may be directly fed back to the eNB 200-2 without passing through the eNB 200-1.

In the above-described embodiment and modification thereof, when there is no UE 100-2 that feeds back the beamforming control information that matches the null-steering control information, the eNB 200-2 selects, as the pair UE, the UE 100-2 that feeds back the beamforming control information including RI=4. However, when there is no UE 100-2 that feeds back the beamforming control information that matches the null-steering control information, the eNB 200-2 may stop applying the CB-CoMP. In this case, the second CQI preferably is CQI derived on the assumption that the CB-CoMP is not applied, rather than CQI derived on the assumption that previously defined RI=4.

In the above-described embodiment and modification thereof, the BCI is described as an example of the null-steering control information; however, WCI (Worst Companion PMI) may be used instead of the BCI. The WCI is an indicator indicating a precoder matrix in which an interference level from an interference source is high. The eNB 200 receives the beamforming control information (PMI, RI) fed back from each of the plurality of UEs 100-2 and the null-steering control information (WCI, RI) fed back from the UE 100-1. Then, the eNB 200 selects the UE 100-2 that feeds back the beamforming control information that matches the null-steering control information, as a pair UE (pair terminal) that forms a pair with the UE 100-1. In this case, the “beamforming control information that matches the null-steering control information” is beamforming control information that includes the PMI that does not match the WCI included in the null-steering control information, or that does not include the RI that matches the RI included in the null steering control information.

In the above-described embodiments, as one example of the cellular communication system, the LTE system is described; however, the present invention is not limited to the LTE system, and the present invention may be applied to systems other than the LTE system.

In addition, the entire content of Japanese Patent Application No. 2013-133653 (filed on Jun. 26, 2013) is incorporated in the present specification by reference.

### INDUSTRIAL APPLICABILITY

As described above, according to the present invention, it is possible to provide a mobile communication system capable of appropriately setting a modulation and coding scheme when downlink multi-antenna transmission is applied, a user terminal thereof, and a communication control method therefor.

1. A mobile communication system transmitting by downlink multi-antenna transmission from a radio access network to a user terminal, wherein
the user terminal comprises:
a transmitter configured to transmit null-steering control information for directing a null to the user terminal in a transmission from the radio access network to another user terminal, and first channel quality information on a modulation and coding scheme recommended when the null-steering control information is adopted in the radio access network, to the radio access network; and
a controller configured to control to transmit, instead of transmitting the first channel quality information or in addition to transmitting the first channel quality information, second channel quality information on a modulation and coding scheme recommended when the null-steering control information is not adopted in the radio access network, to the radio access network.

2. The mobile communication system according to claim 1, wherein
when not adopting the null-steering control information from the user terminal, the radio access network adopts previously defined null-steering control information, and
the second channel quality information is information on a modulation and coding scheme recommended when the previously defined null-steering control information is adopted in the radio access network.

3. The mobile communication system according to claim 1, wherein
the user terminal further comprises a receiver configured to receive, from the radio access network, setting information for switching to the second channel quality information when transmitting the first channel quality information, and
the controller controls, upon receiving the setting information in the receiver, to transmit to the radio access network the second channel quality information instead of transmitting the first channel quality information.

4. The mobile communication system according to claim 1, wherein
the radio access network comprises:
a first base station configured to manage a serving cell of the user terminal; and
a second base station configured to manage a serving cell of the other user terminal, wherein
the first base station receives the null-steering control information from the user terminal and transfers the null-steering control information to the second base station, and
the second base station transmits a notification regarding whether or not to adopt the null-steering control information, to the first base station.

5. The mobile communication system according to claim 4, wherein
when a period during which the null-steering control information is not adopted exceeds a constant period, the first base station transmits to the user terminal setting information for switching to the second channel quality information.

6. A user terminal used in a mobile communication system transmitting by downlink multi-antenna transmission from a radio access network, comprising:
a transmitter configured to transmit null-steering control information for directing a null to the user terminal in a transmission from the radio access network to another user terminal, and first channel quality information on a modulation and coding scheme recommended when the null-steering control information is adopted in the radio access network, to the radio access network; and
a controller configured to control to transmit, instead of transmitting the first channel quality information or in addition to transmitting the first channel quality information, second channel quality information on a modulation and coding scheme recommended when the null-steering control information is not adopted in the radio access network, to the radio access network.

7. A communication control method used in a mobile communication system transmitting by downlink multi-antenna transmission from a radio access network to a user terminal, comprising the steps of:
transmitting, by the user terminal, null-steering control information for directing a null to the user terminal in a transmission from the radio access network to another user terminal, and first channel quality information on a modulation and coding scheme recommended when the null-steering control information is adopted in the radio access network, to the radio access network; and
transmitting, by the user terminal, instead of transmitting the first channel quality information or in addition to transmitting the first channel quality information, second channel quality information on a modulation and coding scheme recommended when the null-steering control information is not adopted in the radio access network, to the radio access network.
